(19) United States
(12) Patent Application Publication
(10) Pub. No.: US 2013/0181651 A1
(43) Pub. Date: Jul. 18, 2013

(54) APPARATUS AND METHOD FOR CONTROLLING FAN MOTOR

(71) Applicant: Sang Jin LEE, Suwon (KR)

(72) Inventor: Sang Jin LEE, Suwon (KR)

(73) Assignee: Samsung Electro-Mechanics Co., Ltd.

(21) Appl. No.: 13/440,701

(22) Filed: Apr. 5, 2012

(30) Foreign Application Priority Data
Jan. 17, 2012 (KR) 10-2012-0005323

(51) Int. Cl. H02P 7/29

(52) U.S. Cl. 318/503

(57) ABSTRACT

There are provided an apparatus and method for controlling a fan motor. The apparatus for controlling a fan motor includes: a signal generating unit generating a pulse width modulation (PWM) input signal having a predetermined duty value; a memory storing duty correction values according to the duty value of the PWM input signal and driving characteristics of the fan motor therein; and a signal controlling unit generating a PWM output signal for operating the fan motor by using the PWM input signal and the duty correction values stored in the memory.

### CROSS-REFERENCE TO RELATED APPLICATIONS

This application claims the priority of Korean Patent Application No. 10-2012-0005323 filed on Jan. 17, 2012, in the Korean Intellectual Property Office, the disclosure of which is incorporated herein by reference.

### BACKGROUND OF THE INVENTION

1. Field of the Invention

The present invention relates to an apparatus and method for controlling a fan motor, capable of simplifying a circuit and decreasing manufacturing costs through the omission of a separate external element such as a resistor, and precisely adjusting an operation of the fan motor, by generating pulse width modulation (PWM) output signals controlling the fan motor from data stored in a memory.

2. Description of the Related Art

Generally, in the case of a motor whose speed is capable of being controlled, such as a fan motor, the speed may be controlled by adjusting a duty value of a pulse width modulation (PWM) signal. The duty value of the pulse width modulation signal may be determined according to an interval between a turn-on time at which the signal has a high level in one signal period and a turn-off time at which the signal has a low level in one signal period, and a rotational speed of the fan motor may be in proportion to the duty value of the pulse width modulation signal.

Particularly, a rotational speed of a fan motor of a cooling apparatus used in order to prevent overheating in a network device, a server device, or the like, needs to be controlled according to the temperature of the device. It may be preferable to use the PWM signal in controlling the rotational speed of the fan motor according to the temperature of the device as described above, and the rotational speed of the fan motor is required to be in linear proportion to a duty value of the PWM signal in order to efficiently control the rotational speed of the fan motor.

In order to linearly change the rotational speed of the fan motor according to the duty value of the PWM signal, a method of correcting a duty value of a PWM input signal is implemented in an apparatus for controlling a motor. In order to correct the duty value of the PWM input signal, the apparatus for controlling a motor receives a predetermined voltage signal through a voltage divider, or the like, implemented as an external element such as a resistor, converts the predetermined voltage signal into a digital signal in an analog-to-digital converter (ADC), and uses the converted signal to correct the duty value of the PWM input signal. However, in the case of using the external element, whenever fan motor characteristics to be controlled are changed, resistor capacity, or the like, needs to be changed, and a configuration cost of a circuit increases, as well as the complexity thereof.

In the following Patent Documents, Patent Document 1 only discloses a technology for controlling a motor from data stored in a memory and securing a steady motor driving speed, while Patent Document 2 only discloses a technology for correcting an error between an actual duty value driving a motor and a theoretical duty value. As a result, neither Patent Document 1 nor Patent Document 2 discloses a technology for securing linearity between a duty value of a PWM signal and a rotational speed of a motor.

### RELATED ART DOCUMENT

(Patent Document 1) Korean Patent No. KR 10-0892469
(Patent Document 2) Japanese Patent Laid-Open Publication No. JP 2006-166579

### SUMMARY OF THE INVENTION

An aspect of the present invention provides an apparatus and method for controlling a fan motor, capable of decreasing circuit complexity and manufacturing costs, securing linearity between a rotational speed of the fan motor and a duty value of a PWM output signal, and more precisely adjusting a fan motor operation, by correcting a duty value of a PWM input signal from data stored in a memory without an external element such as a resistor to generate the PWN output signal.

According to an aspect of the present invention, there is provided an apparatus for controlling a fan motor, the apparatus including: a signal generating unit generating a pulse width modulation (PWM) input signal having a predetermined duty value; a memory storing duty correction values according to the duty value of the PWM input signal and driving characteristics of the fan motor therein; and a signal controlling unit generating a PWM output signal for operating the fan motor by using the PWM input signal and the duty correction values stored in the memory.

The memory may divide the duty value of the PWM input signal into predetermined sections and store the duty correction values independently determined for each of the sections therein.

The signal controlling unit may generate the PWM output signal such that a linear relationship is maintained between a driving speed of the fan motor and a duty value of the PWM output signal, by using the PWM input signal and the duty correction values stored in the memory.

The signal controlling unit may include: a duty value corrector selecting at least one of the duty correction values stored in the memory according to the duty value of the PWM input signal to correct the duty value of the PWM input signal; and a signal outputter generating the PWM output signal, based on the duty value corrected by the duty value corrector.

The fan motor may be a single phase fan motor.

According to another aspect of the present invention, there is provided a method for controlling an operation of a fan motor, the method including: receiving a PWM input signal having a predetermined duty value; retrieving data for correcting the duty value of the PWM input signal from a memory according to the duty value of the PWM input signal and driving characteristics of the fan motor; and generating a PWM output signal for driving the fan motor by correcting the duty value of the PWM input signal from the data.

In the retrieving, the duty value of the PWM input signal may be divided into predetermined sections, and the data independently determined for each section may be retrieved from the memory.

In the generating of the PWM output signal, the PWM output signal having a duty value maintaining a linear relationship with a driving speed of the fan motor may be generated using the data.

The fan motor may be a signal phase fan motor.

According to another aspect of the present invention, there is provided an apparatus for controlling a fan motor, the apparatus including: a signal generating unit generating a PWM input signal having a predetermined duty value; a memory storing data required for controlling an operation of the fan motor, therein; and a sensor unit detecting an actual rotational speed of the fan motor; and a controlling unit calculating a target rotational speed of the fan motor from the duty value of the PWM input signal and the data stored in the memory and comparing the target rotational speed and the actual rotational speed with each other to determine a duty value of a PWM output signal controlling the fan motor.

The memory may store a ratio of the target rotational speed to the duty value of the PWM input signal as the data therein.

The controlling unit may determine an initial rotational speed initiating the operation of the fan motor and an initial duty value of the PWM output signal initiating the operation of the fan motor from the data stored in the memory.

According to another aspect of the present invention, there is provided a method for controlling a fan motor, the method including: calculating a duty value of a PWM input signal; retrieving data required for controlling an operation of the fan motor from a memory; calculating a target rotational speed of the fan motor from the data and the duty value of the PWM input signal; and determining a duty value of a PWM output signal controlling the fan motor by comparing the target rotational speed and an actual rotational speed of the fan motor with each other.

In the retrieving, a ratio of the target rotational speed to the duty value of the PWM input signal may be retrieved as the data.

In the determining, an initial rotational speed initiating the operation of the fan motor and an initial duty value of the PWM output signal initiating the operation of the fan motor from the data stored in the memory may be determined.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a block diagram showing an apparatus for controlling a fan motor according to an embodiment of the present invention;

FIG. 2 is a flow chart showing a method for controlling a fan motor performed by the apparatus for controlling a fan motor shown in FIG. 1;

FIG. 3 is a graph describing the method for controlling a fan motor shown in FIG. 2;

FIG. 4 is a block diagram showing an apparatus for controlling a fan motor according to another embodiment of the present invention;

FIG. 5 is a flow chart showing a method for controlling a fan motor performed by the apparatus for controlling a fan motor shown in FIG. 4; and

FIG. 6 is a graph describing the method for controlling a fan motor shown in FIG. 5.

### DETAILED DESCRIPTION OF THE EMBODIMENTS

Embodiments of the present invention will be described in detail with reference to the accompanying drawings. These embodiments will be described in detail to enable those skilled in the art to practice the present invention. It should be appreciated that various embodiments of the present invention are different but are not necessarily exclusive. For example, specific shapes, configurations, and characteristics described in an embodiment of the present invention may be implemented in another embodiment without departing from the spirit and the scope of the present invention. In addition, it should be understood that the position and arrangement of individual components in each disclosed embodiment may be changed without departing from the spirit and scope of the present invention. Therefore, a detailed description provided below should not be construed as being restrictive. In addition, the scope of the present invention is defined only by the accompanying claims and their equivalents if appropriate. Similar reference numerals will be used to describe the same or similar functions throughout the accompanying drawing.

Hereinafter, embodiments of the present invention will be described in detail with reference to the accompanying drawings so that those skilled in the art may easily practice the present invention.

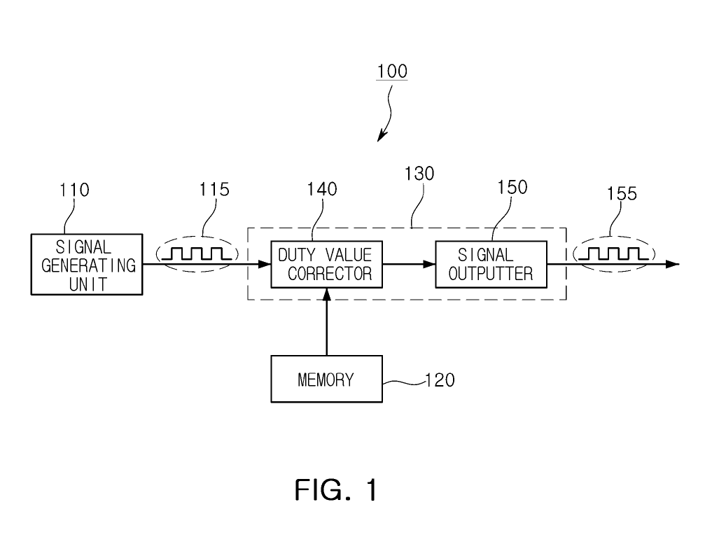

FIG. 1 is a block diagram showing an apparatus for controlling a fan motor according to an embodiment of the present invention.

Referring to FIG. 1, an apparatus 100 for controlling a fan motor according to the embodiment may include a signal generating unit 110, a memory 120, and a signal controlling unit 130, wherein the signal controlling unit 130 may include a duty value corrector 140 and a signal outputter 150.

The signal generating unit 110 may generate a PWM input signal 115 having a predetermined duty value to transfer the PWM input signal to the controlling unit 130. The duty value of the PWM input signal 115, generated by the signal generating unit 110 is used to generate a PWM output signal 155 driving a fan motor. According to the embodiment of the present invention, the duty value of the PWM input signal 115 may be corrected such that a linear relationship between the duty value of the PWM input signal and a rotational speed of the fan motor, for example, one revolution per minute (RPM), is maintained, thereby generating the PWM output signal 155.

The memory 120 may store data required for generating the PWM output signal 155 therein. The data stored in the memory 120 may be retrieved by the signal controlling unit 130 and be used to correct the duty value of the PWM input signal 115. For example, the data stored in the memory 120 may be data for outputting the PWM output signal 155 having a duty value in a linear relationship with the rotational speed of the fan motor from the duty value of the PWM input signal 115. To this end, a range (0 to 100%) of the duty value of the PWM input signal 115 may be divided into predetermined sections, and predetermined pieces of data for correcting the duty value of the PWM output signal 155 may be allocated to each section and then stored in the memory 120.

The duty value corrector 140 may calculate the duty value of the PWM input signal 115 and retrieve predetermined pieces of data corresponding to the calculated duty value from the memory 120. As described above, since pieces of data stored in the memory 120 are differently defined according to sections to which the duty value of the PWM input signal 115 pertains, the duty value corrector 140 may retrieve a specific piece of data in the sections to which the duty value of the PWM input signal 115 pertains.

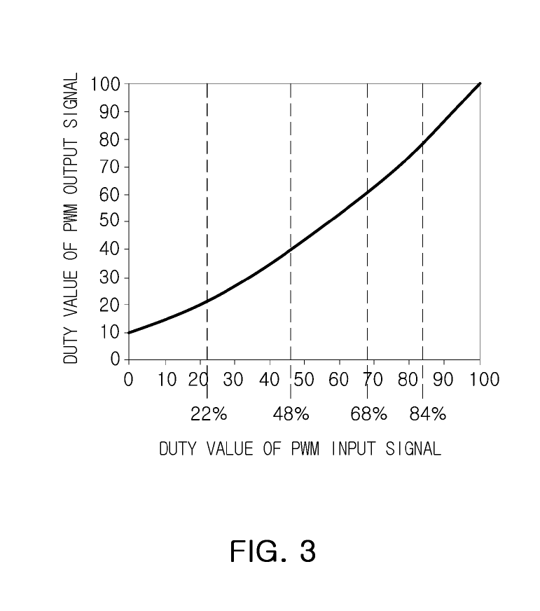

In this case, a plurality of pieces of data may be included in a single section to which the duty value of the PWM input signal 115 pertains. The duty value corrector 140 may select a specific piece of data from among the plurality of pieces of data and select required pieces of data from among the plurality of pieces of data according to characteristics of the fan motor. This will be described below with reference to FIG. 3.

When the duty value of the PWM output signal 155 that may maintain linearity with the rotational speed of the fan motor is determined by the duty value corrector 140, the signal outputter 150 may generate the PWM output signal 155. The PWM output signal 155 may have the duty value determined by the duty value corrector 140 and control the rotational speed of the fan motor. Therefore, the PWM input signal 115 and the PWM output signal 155 actually controlling the rotational speed of the fan motor may have different duty values, and the rotational speed of the fan motor may have a linear relationship with the PWM input signal 115.

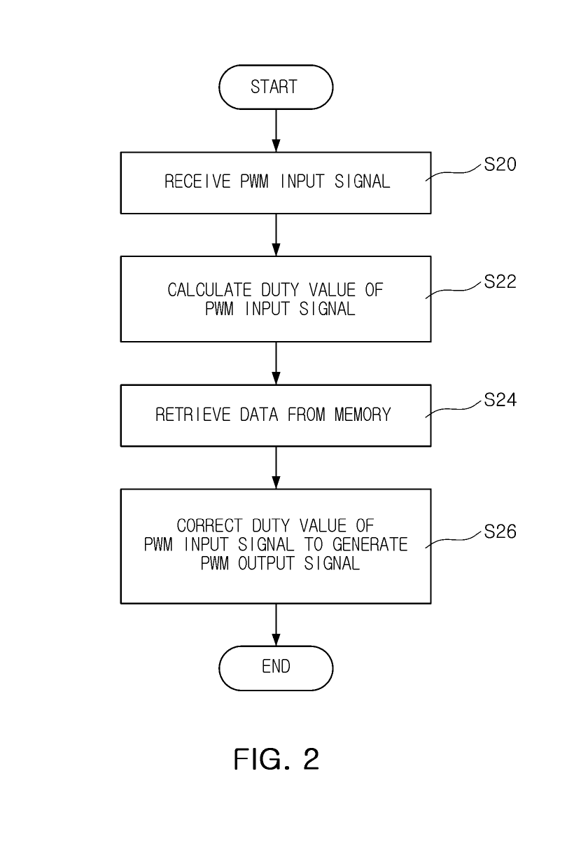

FIG. 2 is a flow chart showing a method for controlling a fan motor performed by the apparatus for controlling a fan motor shown in FIG. 1.

Referring to FIG. 2, the method for controlling a fan motor according to the embodiment may start with receiving the PWM input signal 115 (S20). The PWM input signal 115 may be input to the apparatus 100 for controlling a fan motor from an external system or be generated directly in the apparatus 100 for controlling a fan motor. Although FIG. 1 shows that the PWM input signal 115 is generated directly in the apparatus 100 for controlling a fan motor, the apparatus 100 for controlling a fan motor may also receive the PWM input signal 115 generated on and transmitted from the outside.

In the case in which the PWM input signal 115 is received from the outside, the duty value of the received PWM input signal 115 is calculated (S22). In the case of FIG. 1, the duty value of the PWM input signal 115 may be calculated in the duty value corrector 140 of the signal controlling unit 130. When the duty value of the PWM input signal 115 is calculated, corresponding pieces of data are retrieved from the memory 120, based on the calculated duty value (S24).

As described above, the data stored in the memory 120 may be required to maintain linearity between the duty value of the PWM input signal 115 and the rotational speed of the fan motor. In addition, the duty value of the PWM input signal 115 may be divided into predetermined sections, and independently set pieces of data for each section may be stored. Hereinafter, a description will be provided with reference to FIG. 3.

FIG. 3 is a graph describing the method for controlling a fan motor shown in FIG. 2.

Referring to FIG. 3, a relationship between the duty value of the PWM input signal 115 and the duty value of the PWM output signal 155 is shown as a graph. Each of the duty values of the PWM input signal 115 and the PWM output signal 155 may have a range of 0 to 100%, and the duty value of the PWM input signal 115 may be divided into a total of five sections. Reference duty values by which the duty value of the PWM input signal 115 is divided into five sections may be 22%, 48%, 68%, and 84%, which may be changed according to characteristics, driving environments, and the like, of the fan motor to be controlled.

TABLE 1

| | Duty Value of PWM Input Signal | | | | |
|---|---|---|---|---|---|
| | 0~22% | 22~48% | 48~68% | 68~84% | 84~100% |
| Gradient Section | S1 | S2 | S3 | S4 | S5 |
| 7 | 0.8 | 1.05 | 1.26 | 1.51 | 1.75 |
| 6 | 0.7 | 0.95 | 1.16 | 1.41 | 1.65 |
| 5 | 0.6 | 0.85 | 1.06 | 1.31 | 1.55 |
| 4 | 0.5 | 0.75 | 0.96 | 1.21 | 1.45 |
| 3 | 0.4 | 0.65 | 0.86 | 1.11 | 1.35 |
| 2 | 0.3 | 0.55 | 0.76 | 1.01 | 1.25 |
| 1 | 0.2 | 0.45 | 0.66 | 0.91 | 1.15 |
| 0 | 0.1 | 0.35 | 0.56 | 0.81 | 1.05 |

Table 1 shows an example of pieces of data that may be stored in the memory 120. The duty value of the PWM input signal 115 may be divided into a total of five sections, and eight pieces of data may be allocated to each section in order to correct a difference in duty values between the PWM input signal 115 and the PWM output signal 155. According to characteristics of the fan motor to be controlled, pieces of data required for correcting a corresponding duty value of the PWM input signal 115 in each section may be selected. For example, in the case in which the fan motor to be controlled is determined as a specific motor, respective values of 0.5, 0.75, and 0.96 stored in a fourth address of the memory 120 may be selected as pieces of data required for correcting duty values in sections S1 to S3. In addition, respective values of 1.11 and 1.35 corresponding to a third address of the memory 120 may be selected as pieces of data required for correcting duty values in sections S4 and S5.

When pieces of data required for correcting a corresponding duty value of the PWM input signal 115 in each section are determined, the pieces of data are retrieved according to a section to which the corresponding duty value of the PWM input signal 115 pertains (S24), and the corresponding duty value of the PWM input signal 115 is corrected with reference to the retrieved pieces of data to generate the PWM output signal (S26). For example, since a case in which the duty value of the PWM input signal is 40% corresponds to section S2 of Table 1, 0.75, data selected in section S2, may be retrieved from the memory 120 and be used as data required for correcting the duty value. When a fan motor to be controlled is changed, pieces of data selected from within each section may also be changed accordingly.

The rotational speed of the fan motor may be determined by the duty value of the PWM output signal 155 generated through the above-mentioned process. Therefore, even in the case in which a linear relationship does not exist between the duty value of the PWM input signal 115 and the rotational speed of the fan motor, the apparatus 100 for controlling a fan motor internally generates the PWM output signal 155 of which an error has been corrected to control the rotational speed of the fan motor, whereby a linear relationship between the PWM input signal 115 and the rotational speed of the fan motor may be maintained. In addition, since the data stored in the memory are read to correct the duty value of the PWM input signal 115, a separate external element such as a resistor is not required, whereby circuit complexity may be decreased and a competitive cost may be increased.

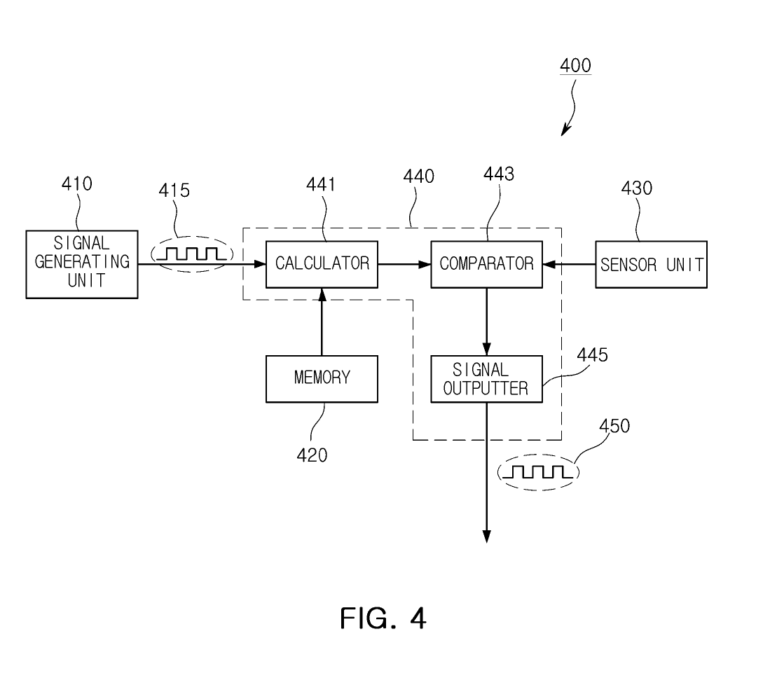

FIG. 4 is a block diagram showing an apparatus for controlling a fan motor according to another embodiment of the present invention.

Referring to FIG. 4, an apparatus 400 for controlling a fan motor according to the embodiment may include a signal generating unit 410, a memory 420, a sensor unit 430, and a controlling unit 440. The signal generating unit 410 may generate a PWM input signal 415 to transfer the PWM input signal 415 to the controlling unit 440. The sensor unit 430 may detect an actual rotational speed of a fan motor to be controlled by the apparatus 400 for controlling a fan motor and include, for example, a hall sensor.

The PWM input signal 415 may be transferred to the controlling unit 440, and a calculator 441 may calculate a duty value of the PWM input signal 415. The memory 420 may store data on a relationship between the duty value of the PWM input signal 415 and a rotational speed of the fan motor, for example, a RPM value, therein. The calculator 441 may calculate a target rotational speed of the fan motor to be implemented by the PWM input signal 415 using the duty value of the PWM input signal 415 and data retrieved from the memory 420.

The target rotational speed calculated by the calculator 441 and the actual rotational speed of the fan motor detected by the sensor unit 430 may be input to a comparator 443, and the comparator 443 may detect an error between the target rotational speed and the actual rotational speed. When it is determined that an error exists between the target rotational speed and the actual rotational speed, the comparator 443 may transfer the detected error to a signal outputter 445, and the signal outputter 445 may adjust a duty value of a PWM output signal transferred to the fan motor, through the reflection of the error. Therefore, the RPM of the fan motor may be controlled such that it may be changed according to the duty value of the PWM input signal 415.

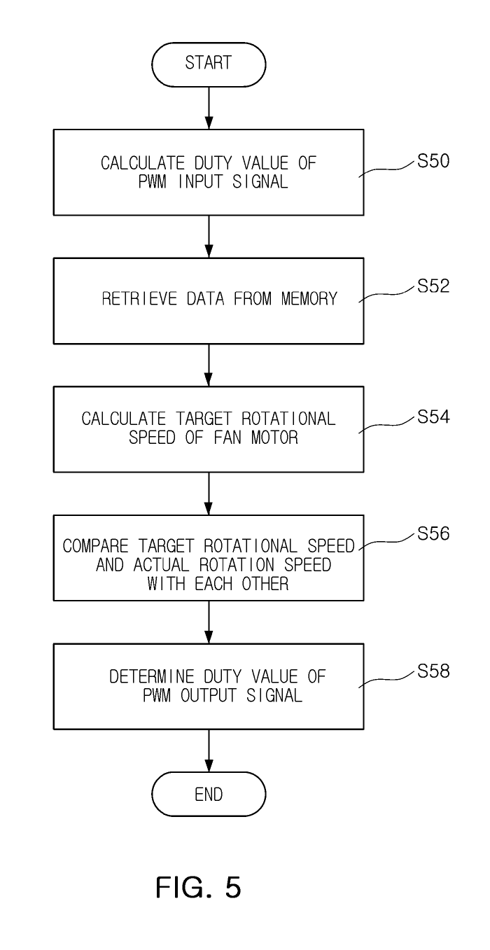

FIG. 5 is a flow chart showing a method for controlling a fan motor performed by the apparatus for controlling a fan motor shown in FIG. 4.

Referring to FIG. 5, the method for controlling a fan motor according to the embodiment starts with calculating the duty value of the PWM input signal 415 (S50). As described above with reference to FIG. 2, the PWM input signal 415 may be generated in the apparatus 400 for controlling a fan motor or be generated on the outside and then transferred to the apparatus 400 for controlling a fan motor.

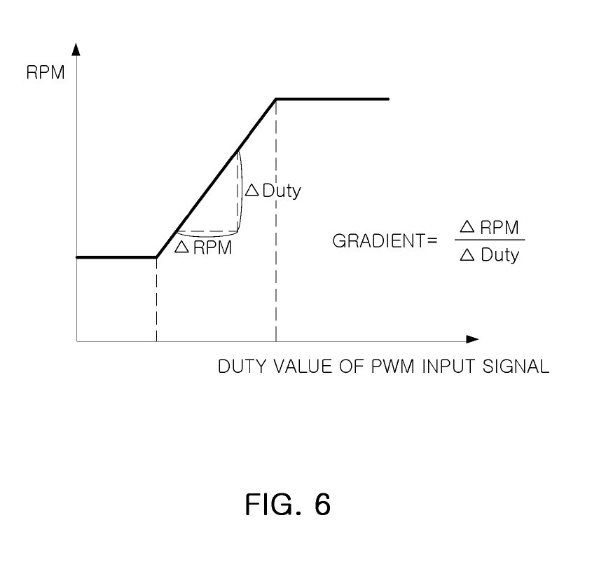

When the duty value of the PWM input signal 415 is calculated, pieces of data for calculating a target rotational speed of the fan motor are retrieved from the memory 420 (S52). As described above with reference to FIG. 3, the rotational speed of the fan motor may have a linear relationship with the duty value of the PWM input signal 415. Therefore, the data retrieved from the memory 420 may be defined as a ratio of a change in rotational speed of the fan motor to a change in duty value of the PWM input signal 415. Hereinafter, a description will be provided with reference to FIG. 6.

FIG. 6 is a graph describing the method for controlling a fan motor shown in FIG. 5.

Referring to FIG. 6, the duty value of the PWM input signal 415 may have a linear relationship with an RPM value of the fan motor, which indicates the rotational speed of the fan motor, within a predetermined range. That is, the data stored in the memory 420 may correspond to a gradient in the graph of FIG. 6 corresponding to a ratio of a change (^{Δ}RPM) in rotational speed of the fan motor to a change (^{Δ}Duty) in duty value of the PWM input signal 415. The gradient in the graph of FIG. 6 may be changed according to characteristics of the fan motor to be controlled, and the controlling unit 440 of the apparatus 400 for controlling a fan motor may retrieve required data, that is, the gradient from the memory 420 according to the characteristics of the fan motor and use the retrieved data to calculate the target rotational speed of the fan motor.

The controlling unit 440 calculates the target rotational speed of the fan motor from the duty value of the PWM input signal 415 and the data retrieved from the memory 420 (S54) and compares the target rotational speed with the actual rotational speed of the fan motor detected by the sensor unit 430 (S56). When it is determined that a difference between the actual rotational speed and the target rotational speed is present, the difference is reflected to determine the duty value of the PWM output signal 450 (S58). Therefore, the actual rotational speed of the fan motor may be controlled such that it may be determined according to the duty value of the PWM input signal 415, and an external element such as a resistor may be omitted. Accordingly, circuit complexity and manufacturing costs may be decreased.

As set forth above, according to the embodiments of the present invention, linearity between the rotational speed of the fan motor and the duty value of the PWM output signal is secured using the data stored in the memory without an external element such as a resistor, whereby the complexity of the circuit and manufacturing costs may be decreased, the fan motor may be precisely controlled, and the duty value of the PWM output signal may be easily adjusted in the case in which characteristics of the fan motor are changed.

In addition, the PWM output signal for initial driving of the fan motor is generated with reference to the data stored in the memory regardless of the PWM input signal, whereby a phenomenon in which instantaneous overcurrent is applied at the time of initial driving of the fan motor may be prevented.

While the present invention has been shown and described in connection with the embodiments, it will be apparent to those skilled in the art that modifications and variations can be made without departing from the spirit and scope of the invention as defined by the appended claims.

What is claimed is:

1. An apparatus for controlling a fan motor, the apparatus comprising:
a signal generating unit generating a pulse width modulation (PWM) input signal having a predetermined duty value;
a memory storing duty correction values according to the duty value of the PWM input signal and driving characteristics of the fan motor therein; and
a signal controlling unit generating a PWM output signal for operating the fan motor by using the PWM input signal and the duty correction values stored in the memory.

2. The apparatus of claim 1, wherein the memory divides the duty value of the PWM input signal into predetermined sections and stores the duty correction values independently determined for each of the sections therein.

3. The apparatus of claim 1, wherein the signal controlling unit generates the PWM output signal such that a linear relationship is maintained between a driving speed of the fan motor and a duty value of the PWM output signal, by using the PWM input signal and the duty correction values stored in the memory.

4. The apparatus of claim 1, wherein the signal controlling unit includes:
a duty value corrector selecting at least one of the duty correction values stored in the memory according to the duty value of the PWM input signal to correct the duty value of the PWM input signal; and
a signal outputter generating the PWM output signal, based on the duty value corrected by the duty value corrector.

5. The apparatus of claim 1, wherein the fan motor is a single phase fan motor.

6. A method for controlling an operation of a fan motor, the method comprising:
receiving a PWM input signal having a predetermined duty value;
retrieving data for correcting the duty value of the PWM input signal from a memory according to the duty value of the PWM input signal and driving characteristics of the fan motor; and
generating a PWM output signal for driving the fan motor by correcting the duty value of the PWM input signal from the data.

7. The method of claim 6, wherein in the retrieving, the duty value of the PWM input signal is divided into predetermined sections, and the data independently determined for each section is retrieved from the memory.

8. The method of claim 6, wherein in the generating of the PWM output signal, the PWM output signal having a duty value maintaining a linear relationship with a driving speed of the fan motor is generated using the data.

9. The method of claim 6, wherein the fan motor is a signal phase fan motor.

10. An apparatus for controlling a fan motor, the apparatus comprising:
a signal generating unit generating a PWM input signal having a predetermined duty value;
a memory storing data required for controlling an operation of the fan motor, therein; and
a sensor unit detecting an actual rotational speed of the fan motor; and
a controlling unit calculating a target rotational speed of the fan motor from the duty value of the PWM input signal and the data stored in the memory and comparing the target rotational speed and the actual rotational speed with each other to determine a duty value of a PWM output signal controlling the fan motor.

11. The apparatus of claim 10, wherein the memory stores a ratio of the target rotational speed to the duty value of the PWM input signal as the data therein.

12. The apparatus of claim 10, wherein the controlling unit determines an initial rotational speed initiating the operation of the fan motor and an initial duty value of the PWM output signal initiating the operation of the fan motor from the data stored in the memory.

13. A method for controlling a fan motor, the method comprising:
calculating a duty value of a PWM input signal;
retrieving data required for controlling an operation of the fan motor from a memory;
calculating a target rotational speed of the fan motor from the data and the duty value of the PWM input signal; and
determining a duty value of a PWM output signal controlling the fan motor by comparing the target rotational speed and an actual rotational speed of the fan motor with each other.

14. The method of claim 13, wherein in the retrieving, a ratio of the target rotational speed to the duty value of the PWM input signal is retrieved as the data.

15. The method of claim 13, wherein in the determining, an initial rotational speed initiating the operation of the fan motor and an initial duty value of the PWM output signal initiating the operation of the fan motor from the data stored in the memory are determined.
